(19) United States
(12) Patent Application Publication
(10) Pub. No.: US 2013/0226608 A1
(43) Pub. Date: Aug. 29, 2013

(54) SYSTEM FOR IDENTIFYING, MONITORING, INFLUENCING AND REWARDING HEALTHCARE BEHAVIOR

(71) Applicants: Christopher Di Lascia, Shrewsbury, NJ (US); Francis Di Lascia, Monmouth Beach, NJ (US); Raman Kapur, Princeton, NJ (US); Wilfred Shearer, Basking Ridge, NJ (US); Edward Sadowski, Burlington, NJ (US); Jason Riddle, Huntington Beach, CA (US); Adam Robles, Irvine, CA (US)

(72) Inventors: Christopher Di Lascia, Shrewsbury, NJ (US); Francis Di Lascia, Monmouth Beach, NJ (US); Raman Kapur, Princeton, NJ (US); Wilfred Shearer, Basking Ridge, NJ (US); Edward Sadowski, Burlington, NJ (US); Jason Riddle, Huntington Beach, CA (US); Adam Robles, Irvine, CA (US)

(21) Appl. No.: 13/780,989

(22) Filed: Feb. 28, 2013

Related U.S. Application Data
(60) Provisional application No. 61/604,383, filed on Feb. 28, 2012.

(51) Int. Cl. G06F 19/00

(52) U.S. Cl. CPC G06F 19/3431
USPC 705/2

(57) ABSTRACT

Systems and methods for identifying, monitoring, influencing and rewarding positive healthcare behavior are provided. The method and system includes a device receiving patient specific data which include patient care indicators associated with the patient. The device compares the patient specific data against a database that relates each patient care indicator with at least one patient care module. The device generates customized patient care plan that includes patient care modules. The patient specific data also includes one or more compliance indicators, indicating the patient's interactions with the patient care modules. The device assesses patient behavior based on the compliance indicator. A reward is issued to a patient on a condition that the patient adheres to the customized patient care plan

### CROSS REFERENCE TO RELATED APPLICATION

This application claims priority to U.S. Provisional Patent Application No. 61/604,383 filed Feb. 28, 2012, the contents of which is hereby incorporated by reference in its entirety.

### STATEMENT OF THE TECHNICAL FIELD

Embodiments include computing systems and methods for identifying, monitoring, influencing and rewarding positive healthcare behavior.

### BACKGROUND

### Description of the Related Art

Research strongly suggests that care coordination failures are common and can lead to avoidable health care costs. For example, unplanned hospital readmissions cost the U.S. healthcare system an estimated $17 billion. The Institute for Health Improvement (IHI) believes up to 46% of readmissions could be prevented.

Under the Patient Protection and Affordable Care Act (PPACA) and the Value Based Purchasing Initiative (VBPI) put forward by the Centers for Medicare & Medicaid Services (CMS), providers are incentivized, through rewards and penalties, to improve care coordination, and patient outcomes. Additional mandates in PPACA also connect reimbursement to Hospital Consumer Assessment of Healthcare Providers and Systems (HCAHPS) patient satisfaction ratings. Because of this increasing financial risk for providers, the marketplace is driving the need for better-educated patients and improved care transition.

An interactive voice response (IVR) program implemented with a New Jersey health system was deemed a success in decreasing the readmission rate for CHF patients being readmitted for CHF from 14.93% in January to 5.6% by July 2010 after a 6-month implementation of the program. The overall trend for readmission rates from 2009 compared with 2010 indicated a clear decrease of nearly 12%. Healthcare providers (hospitals, health systems, accountable care organizations, physicians and medical professionals, and other healthcare providers), payers (insurers, employers and government) and manufacturers (Pharma, Biotech, Device) all have a vested interest in patient compliance and in the improved health of patients. “Good patients” (as defined by compliance and healthy lifestyle behaviors) typically have improved outcomes and return a benefit to the healthcare providers including improved medication compliance and increased compliance with the prescribed care plan, improved efficiency, and improved performance metrics. Payors also benefit through reductions in costly episodes of care such as fewer hospitalizations and physician visits, care provided at the most cost-effective site, and an overall lower cost of care.

Given the need for cost reduction, healthcare providers are increasingly being placed at risk for their patient care decisions with financial incentives tied to patient outcomes, and are seeking tools to help them create opportunities to intervene and support patients in a meaningful way and drive positive patient health behavior. Traditional efforts often involve phone calls requiring the time and effort of a nurse, administrator, or other staff at a high cost. As providers, payers, and others seek to improve transition of care, management of chronic diseases, and reduce costs, more and more are using technology to assist with patient monitoring.

### SUMMARY

The present invention addresses the shortcomings in the prior art. Embodiments concern implementing systems/devices and methods for tracking and modifying a patient's behavior. In one scenario, the method includes a device receiving a first set of patient specific data comprising information that identifies a patient and receiving a second set of patient specific data comprising one or more patient care indicators associated with the patient. The device compares the second set of patient specific data against a database that relates each patient care indicator with at least one patient care module. The device generates customized patient care plan that includes one or more patient care module(s) wherein each module includes one or more activity(ies) assigned to the patient. The method also includes receiving a third set of patient specific data comprising one or more compliance indicators, wherein the one or more compliance indicators indicate the patient's interactions with the one or more of patient care module(s). The device assesses patient behavior based on the third set of patient specific data, wherein the one or more compliance indicators indicate whether the patient completed the activity(ies) assigned to the patient. A reward is issued to a patient on a condition that the patient adheres to the customized patient care plan, enabling the patient to utilize the reward.

Scenarios are also provided which disclose a system and/or device for tracking and modifying a patient's behavior. The system/device includes a terminal configured to capture patient specific, a data a processor, and a computer readable medium configured to store program instructions which, when executed, cause the processor to generate a customized patient care plan comprising one or more patient care module(s) wherein each module includes one or more activity(ies) assigned to the patient by comparing a second set of patient specific data comprising one or more patient care indicators associated with the patient against a database that relates each patient care indicator with at least one patient care module. The instructions, when executed, also cause the processor to assess patient behavior based on a third set of patient specific data comprising one or more compliance indicators, wherein the one or more compliance indicators indicate the patient's interactions with the one or more of patient care module(s), wherein the one or more compliance indicators indicate whether the patient completed the activity(ies) assigned to the patient. The instructions, when executed also cause the processor to issue a reward to a patient on a condition that the patient adheres to the customized patient care plan, enabling the patient to utilize the reward.

### BRIEF DESCRIPTION OF THE DRAWINGS

Embodiments will be described with reference to the following drawing figures, in which like numerals represent like items throughout the figures, and in which:

FIG. 1 is a system diagram showing an implementation of the patient tracking and incentivizing platform.

FIG. 2 is a block diagram of an example communication device.

FIG. 3 is a block diagram of an example server.

FIG. 4 is a system diagram showing an implementation of the platform.

FIG. 5 is a block diagram showing an implementation of a provider user role.

FIG. 6 is a block diagram showing an implementation of a patient user role.

FIG. 7 is a flow chart showing a method for tracking and incentivizing a patient's behavior.

FIG. 8 is a flow chart showing a method for awarding points.

FIG. 9 is a flow chart showing a method for performing interventions.

FIG. 10 is a flow chart showing a method of implementing reminders.

### DETAILED DESCRIPTION OF THE INVENTION

Example implementations of the disclosed scenarios are described with reference to the attached figures. The figures are not drawn to scale and they are provided merely to illustrate the instant invention. Several aspects are described below with reference to example applications for illustration. It should be understood that numerous specific details, relationships, and methods are set forth to provide a full understanding of the disclosed implementations. One having ordinary skill in the relevant art, however, will readily recognize that the invention can be practiced without one or more of the specific details or with other methods. In other instances, well-known structures or operation are not shown in detail to avoid obscuring the invention. The disclosed implementations is not limited by the illustrated ordering of acts or events, as some acts may occur in different orders and/or concurrently with other acts or events. Furthermore, not all illustrated acts or events are required to implement a methodology in accordance with the disclosed scenarios.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Various scenarios described provide an integrated platform of technology and patient services that tracks and incentivizes patient medication compliance, participation in health related patient education, and other positive health behaviors. Platform may include a points-driven system for incentivizing patient compliance and positive health related behaviors, resulting in reduced healthcare costs, increased patient satisfaction, and improved outcomes. In return for demonstrating health learning and meeting important healthcare milestones, “good patients” earn points and have access to discounts on health-related products and services and other rewards.

The present invention is directed to a patient driven system platform that allows all stakeholders (including patients, providers, payers, and manufacturers) to benefit from creating and empowering “good patients.” The platform focuses on three main drivers, medication access and adherence, patient education, and patient healthcare journey support.

Medication Access and Adherence

Medication Access Support—The platform provides a method for tracking prescription acquisition and fulfillment. If a delay in prescription access is identified, patients receive an electronic communication such as an interactive voice response (IVR) call or text message to prompt them to fill their prescriptions and offers medication access assistance. Timely completion of target activities is rewarded with points.

Medication Adherence Support—The platform provides a method for tracking a patient's medication adherence with a combination of IVR compliance surveys and tracking of prescription refills. If a delay medication refill is identified, patients receive an electronic communication such as an IVR call or text message to prompt them to refill their prescription and offers assistance. Good compliance and timely refills of medication is rewarded with points.

Patient Education

The platform provides for interactive patient education that combines web-based education resources, e-mail based education support, and hard copy education materials with web-based and IVR testing. Active patient participation and test scores are rewarded with points.

Patient Journey Support

Healthy Behavior/Patient Journey Support—The platform allows the tracking of a patient's healthcare related activities such as visiting their physician, getting needed lab tests and vaccinations, and the like. If a delay in an activity is identified, patients receive an IVR call to prompt them to perform the activity and offers access to assistance.

The platform may provide a series of IVR calls with survey questions designed to assess patient information. If a patient's responses identify a need, the platform can then transfer the call, send an e-mail or a text message to a caregiver and/or healthcare provider as directed.

The platform may provide web based resources that allow for patient-to-patient connectivity via social media including “live” chat rooms, bulletin boards, integration with popular social media sites, and links and/or integration with patient support group sites.

The platform may provide multichannel delivery of patient resources—including but not limited to web-based, phone, and hard copy—allowing for the simplest and broadest patient access possible. In at least one aspect of the invention, a card, with IVR activation and opt-in, may provide patients with an easy entre into the platform. The web site, designed for the exclusive enrollment and use of end users, may offer patients access to their activity history, points management, and act as a focal point for delivery of patient education and additional discounts and offers.

Patient data may be obtained directly from the participating patients and providers, via the patient enrollment during the hospital discharge process, through direct link to an electronic medical record, and/or through device-driven (e.g card, smart phone, and the like) patient behavior tracking and surveys. Data may include but is not limited to patient demographics, diagnoses (DRG), prescription acquisition and adherence data, post-discharge patient behavior data, readmission data, patient satisfaction and other metrics important to key stakeholders.

In another aspect of the invention, the presently described platform offers a marketplace for patients to exchange positive healthcare behavior for personal financial rewards. This feature acknowledges patient as a financial stakeholder in their own health care, and gives patients a “seat at the table” for share of health care return on investment.

To achieve good patient status, patients will document participation in ongoing, certified health education and health care support programs, specifically designed and validated to improve patient outcomes. In return for good patient status, patients will derive a financial benefit via rebates, discounts, and other valuable rewards.

At least one embodiment is directed to a software platform, which includes communications methods including, but not limited to SMS text messages or other text or voice messages, IVR phone calls, e-mails, faxes, and other communications received a smart phone, cell phone, computer, tablet computer, land line phone, and/or other communication device, for delivering information, surveys, and education. One such embodiment includes the ability to send and receive real-time point-of-service messages triggered by patient activities, as described below.

In another scenario, the present invention may include technology for monitoring and assessing patient information such as biometric inputs (blood pressure, heart rate, blood glucose, weight, and other measures accessible to the patient, care giver, or healthcare provider). The inputs can be used by the platform to allow the patient to be triaged to an appropriate provider or caregiver. Acceptable readings or performance with a biometric device can be rewarded with points.

One scenario includes a web-based portal that provides for automated management of activities including education, communication, reward tracking, and data management for the purposes of monitoring, educating, and favorably influencing patient behavior such as medication adherence and compliance. The web-based portal also serves as a point that links patients, healthcare providers (including home health agencies, physicians, case managers, and the like) and non healthcare persons such as family and caregivers, providing access to patient specific data in an interactive, permission-based, social network environment.

The web portal may provide additional healthcare functions, including providing data necessary for post-discharge patient management, establishing real-time connectivity between multiple providers, allowing remote access to patient information and status to caregivers (e.g., child in California can assist parent in Florida with care needs), alerts to participants for activity performed on the patient's behalf (e.g., notes from a home health provider visit), access to key-word medical information and patient education materials with testing and performance tracking, access links to the full suite of services including medication access and compliance support, patient care plan reminders, and the like.

The web portal may provide a vehicle for hospitals, health systems, physician practices and other healthcare institutions to establish a relationship with patients for the purpose of marketing and sales. It also establishes a potential revenue stream for these entities from both recruiting patients for elective procedures and other services, and from selling advertising space on the portal to businesses interested in reaching people actively focused on their health.

One scenario includes proprietary social media methods such as chat rooms, blogs, bulletin boards, and the like for the purposes of allowing for patient-to-patient communications to drive improvement in medication compliance, care plan compliance, patient education, patient monitoring, and patient behavior.

The preferred embodiment includes integration with existing social media channels to provide a collective reward system where individuals or companies contribute rewards of value to a group/community of end users to support healthy behaviors. Examples of social media integration include: the use of social media sites for mutually supportive activities to increase adherence amongst chronic disease sufferers and other similar groups; use of sites, including physician practice websites, to connect care-givers to the patient and the physician to enhance adherence to a target regiment; use of social media websites to send messages regarding the latest developments in specific medical fields to enhance compliance; use of social media websites to send messages about the latest coupon or other reward available to a target group to enhance compliance; use of social media websites as an automated reminder and teaching tool to enhance adherence; use of social media websites as an appointment tool as part of a healthcare regimen to increase adherence; use of social media websites to notify the group about the availability of the latest web or smartphone applications to enhance adherence for chronic diseases.

At least one aspect of the present invention is directed to benefiting patients with acute care needs including those who may be admitted six times or more in the year; readmitted to a healthcare facility within 30, 45, or 60 days after discharge; identified “at risk” on facility admission screens, are identified by family members as such or willing to enroll in a transition care program voluntarily. Such patient population tends to more frequently utilize the healthcare resource by for example being readmitted to the hospital within 30 days for the same issues after they are discharged from a hospital or another care facility.

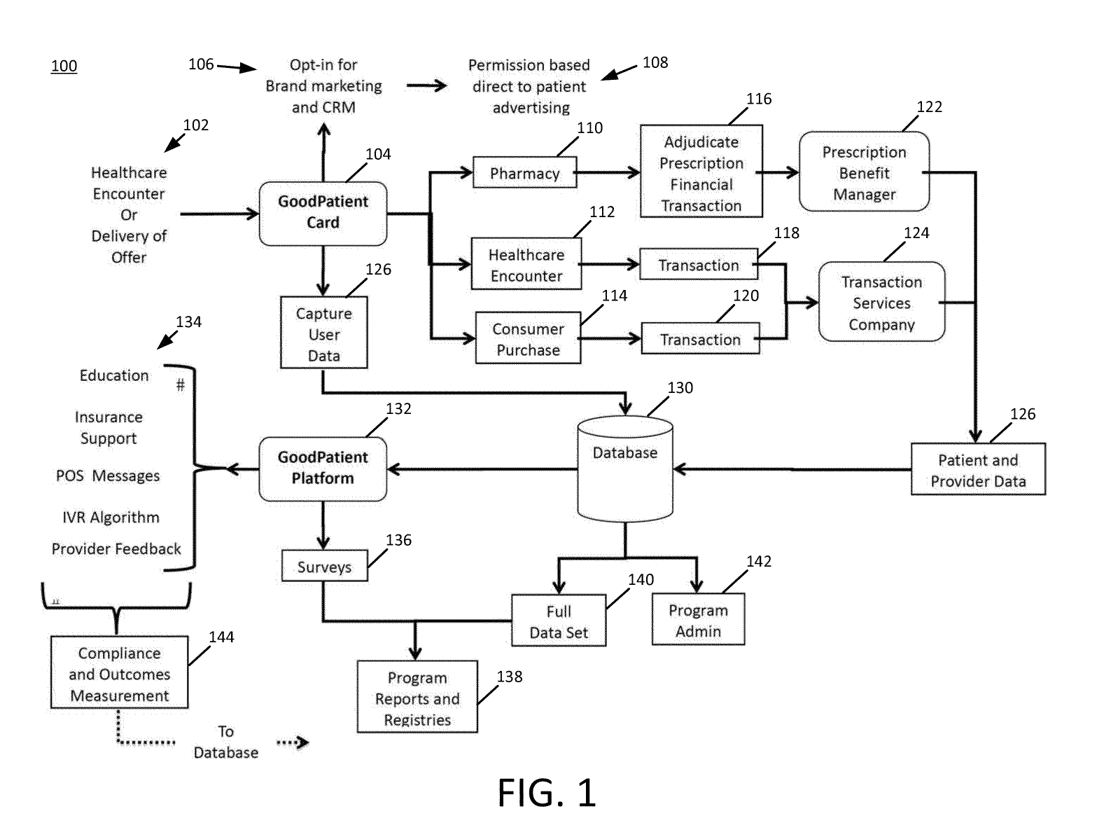

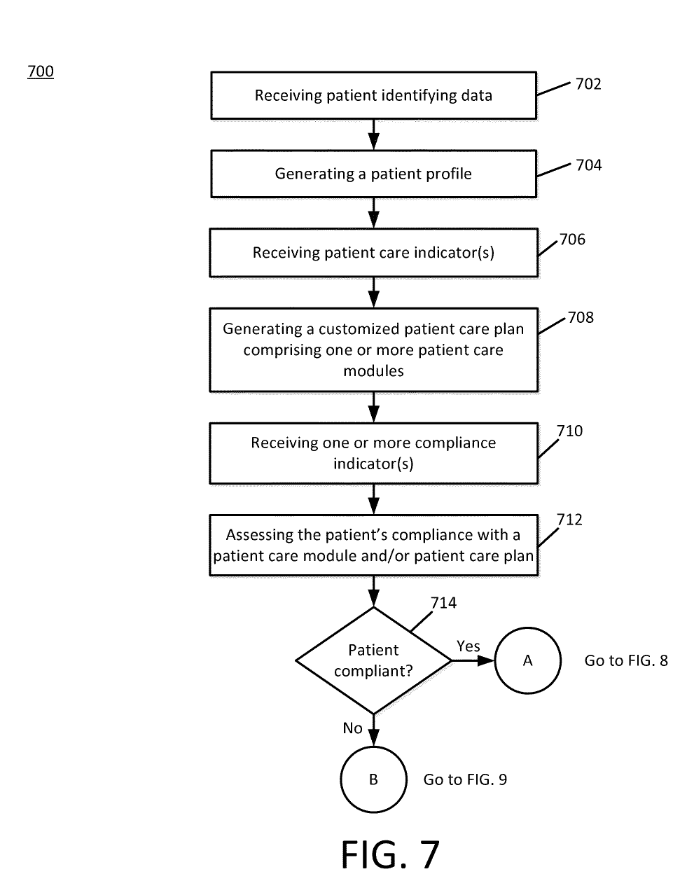

Exemplary implementing system embodiments of the present invention will be described below in relation to FIGS. 1-6. Exemplary method embodiments of the present invention will be described below in relation to FIGS. 7-10.

Exemplary Systems

Referring now to FIG. 1, there is provided a flow chart that illustrates the general structure of the disclosed system. When a patient engages in a healthcare service or encounter 102 he/she may use a card and/or smart phone or device 104 as the method initiate services. The card may be any card which identifies the patient for the purpose of interacting with the system and may include a customer loyalty card, a credit card, and an identification card. The device 104 is capable of capturing end user data 126 which can be used for the activation, registration, and/or opt in to a service program 106, advertising and marketing program 108, and receipt of services by a patient, as described below. This information may be stored in a database 130.

In at least one embodiment the patient has the ability to provide the card or device 104 at a pharmacy 110, in conjunction with a purchase, including a prescription, for the purposes of receiving a discount or other service. The prescription would be adjudicated and a financial transaction 116 would occur involving a prescription benefit manager (PBM) 122 who, along with their normal services, would provide patient, provider, and transaction data 126 to a database 130 for the purposes of program management 142 including but not limited to providing discounts, offering education and services, rewarding patient behavior, communicating electronically via phone, email, or text message with the patient in “real time” at the point of sale, and reporting.

In another embodiment, the patient has the ability to provide the card or device 104 at a healthcare encounter 112, such as a hospital discharge, physician office visit, medical lab visit, clinic visit, and the like. The patient would use the device 104 to create a record of the healthcare transaction 118, including both non-financial and financial types of transactions, which would be processed using a transaction services company 124 such as a credit card company, who, along with their normal services, would provide patient, provider, and transaction data 126 to a database 130 for the purposes of program management 142, including but not limited to providing discounts, offering education and services, rewarding patient behavior, communicating electronically via phone, email, or text message with the patient in “real time” at the point of service, and reporting.

In yet another embodiment, the patient may have the ability to provide the card or device 104 at a consumer point of purchase 114, such as a grocery store, sporting goods store, health club, internet e-commerce site, and the like. The patient would use the device 104 to create a record of their transaction 120 including both non-financial and financial types of transactions, which would be processed using a transaction services company 124 such as a credit card company, who, along with their normal services, would provide patient, provider, and transaction data 126 to a database 130 for the purposes of program management 142 including but not limited to providing discounts, offering education and services, rewarding patient behavior, communicating electronically via phone, email, or text message with the patient in “real time” at the point of sale, and reporting.

The database 130 may be physical technology such as computer servers or may be web-based technologies such as cloud-based servers and data storage providers. Database 130 may be a single database or may be multiple databases. The scenarios are not limited in this regard. The database 130 would store all patient, provider, and program data required for the operation of the platform 132. The data would be provided for the provision of platform services 134. Platform services 132 may include communication vehicles and technologies that drive improvement in medication compliance, care plan compliance, patient education, patient monitoring, and patient behavior. The impact on compliance and outcomes would be measured 144 and reported to a database 130.

The platform 132 would also survey patients and providers 136 and make this data, alone or in combination with information from the full data set 140 available to patients, providers, customers, and other end users in the form of reports, web-based dashboards, and registries 138.

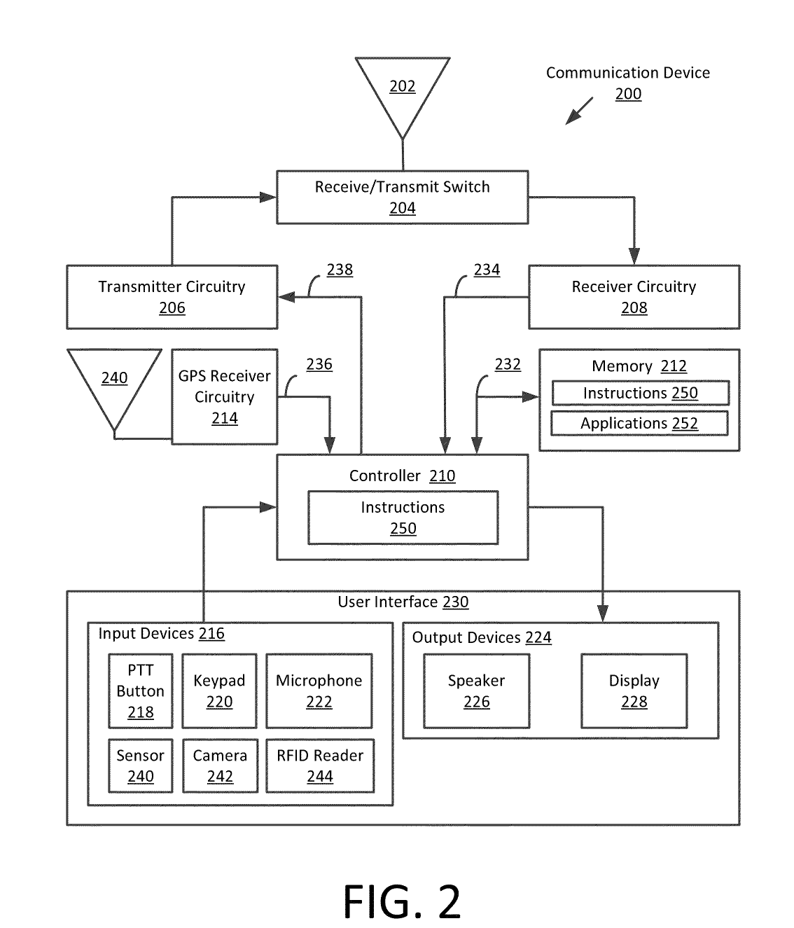

Referring now to FIG. 2, there is provided a more detailed block diagram of the communication device 200. The communication device 200 will be described herein as comprising a mobile phone or a smart phone. However, the present invention is not limited in this regard. For example, the communication device can alternatively comprise a notebook, a laptop computer, a PDA, or a tablet Personal Computer (“PC”).

Notably, the communication device 200 can include more or less components than those shown in FIG. 2. For example, the communication device 200 can include a wired system interface, such as a universal serial bus interface (not shown in FIG. 2). However, the components shown are sufficient to disclose an illustrative embodiment implementing the present invention.

As shown in FIG. 2, the communication device 200 may comprise an antenna 202 for receiving and transmitting Radio Frequency (RF) signals. A receive/transmit (Rx/Tx) switch 204 selectively couples the antenna 202 to the transmitter circuitry 206 and receiver circuitry 208 in a manner familiar to those skilled in the art. The receiver circuitry 208 demodulates and decodes the RF signals received from a network (e.g., the network 104 of FIG. 1) to derive information therefrom. The receiver circuitry 208 is coupled to a controller 210 via an electrical connection 234. The receiver circuitry 208 provides the decoded RF signal information to the controller 210. The controller 210 uses the decoded RF signal information in accordance with the function(s) of the communication device 200. For example, if the RF signals include identifier information and/or location information for other communication devices (e.g., devices 106 of FIG. 1), then the identifier and/or location information can be used by the controller 210 to identify other devices that are pre-defined distances from or within range of the communication device 200. The controller 210 also provides information to the transmitter circuitry 206 for encoding and modulating information into RF signals. Accordingly, the controller 210 is coupled to the transmitter circuitry 206 via an electrical connection 238. The transmitter circuitry 206 communicates the RF signals to the antenna 202 for transmission to an external device (e.g., network equipment of network 104 of FIG. 1). An antenna 240 is coupled to GPS receiver circuitry 214 for receiving GPS signals. The GPS receiver circuitry 214 demodulates and decodes the GPS signals to extract GPS location information therefrom.

The controller 210 stores the decoded RF signal information and the decoded GPS location information in a memory 212 of the communication device 200. Accordingly, the memory 212 is connected to and accessible by the controller 210 through an electrical connection 232. The memory 212 can be a volatile memory and/or a non-volatile memory. For example, the memory 212 can include, but is not limited to, a Random Access Memory (RAM), a Dynamic Random Access Memory (DRAM), a Static Random Access Memory (SRAM), Read-Only Memory (ROM) and flash memory. The memory 212 can also have stored therein the software applications 252.

The software applications 252 include, but are not limited to, applications operative to provide telephone services, network communication services, GPS based services, navigation services, location services, position reporting services, traffic status services, tour information services, commerce services, email services, web based services, and/or electronic calendar services.

As shown in FIG. 2, one or more sets of instructions 250 are stored in the memory 212. The instructions 250 can also reside, completely or at least partially, within the controller 210 during execution thereof by the communication device 200. In this regard, the memory 212 and the controller 210 can constitute machine-readable media. The term “machine-readable media”, as used here, refers to a single medium or multiple media that store the one or more sets of instructions 250. The term “machine-readable media”, as used here, also refers to any medium that is capable of storing, encoding or carrying the set of instructions 250 for execution by the communication device 200 and that cause the communication device 200 to perform one or more of the methodologies of the present disclosure.

The controller 210 is also connected to a user interface 230. The user interface 230 is comprised of input devices 216, output devices 224, and software routines (not shown in FIG. 2) configured to allow a user to interact with and control software applications 252 installed on the computing device 200. Such input and output devices respectively include, but are not limited to, a display 228, a speaker 226, a keypad 220, a directional pad (not shown in FIG. 2), a directional knob (not shown in FIG. 2), a microphone 222, a Push-To-Talk (“PTT”) button 218, sensors 240, a camera 242 and a Radio Frequency Identification (“RFID”) reader 244.

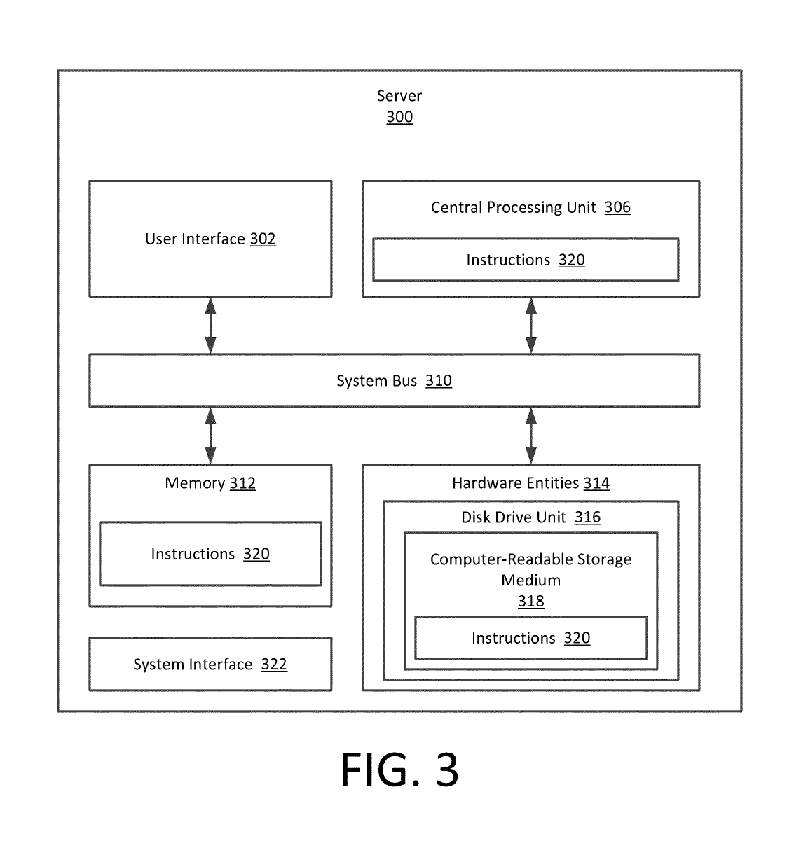

Referring now to FIG. 3, there is provided a more detailed block diagram of the server 300. As shown in FIG. 3, the server 300 comprises a system interface 322, a user interface 302, a Central Processing Unit (CPU) 306, a system bus 310, a memory 312 connected to and accessible by other portions of server 300 through system bus 310, and hardware entities 314 connected to system bus 310. At least some of the hardware entities 314 perform actions involving access to and use of memory 312, which can be a Random Access Memory (RAM), a disk driver and/or a Compact Disc Read Only Memory (CD-ROM). Some or all of the listed components 302-322 can be implemented as hardware, software and/or a combination of hardware and software. The hardware includes, but is not limited to, an electronic circuit.

The server 300 may include more, less or different components than those illustrated in FIG. 3. However, the components shown are sufficient to disclose an illustrative embodiment implementing the present invention. The hardware architecture of FIG. 3 represents one embodiment of a representative server configured to facilitate the provision of services to a user of a communication device (e.g., communication device 200 of FIG. 2).

Hardware entities 314 can include microprocessors, Application Specific Integrated Circuits (ASICs) and other hardware. Hardware entities 314 can include a microprocessor programmed for facilitating the provision of the automatic software function control services to a user of the communication device (e.g., communication device 200 of FIG. 2). In this regard, it should be understood that the microprocessor can access and run various software applications (not shown in FIG. 3) installed on the server 300.

As shown in FIG. 3, the hardware entities 314 can include a disk drive unit 316 comprising a computer-readable storage medium 318 on which is stored one or more sets of instructions 320 (e.g., software code or code sections) configured to implement one or more of the methodologies, procedures, or functions described herein. The instructions 320 can also reside, completely or at least partially, within the memory 312 and/or within the CPU 306 during execution thereof by the server 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the server 300 and that cause the server 300 to perform any one or more of the methodologies of the present disclosure.

System interface 322 allows the server 300 to communicate directly or indirectly with external communication devices (e.g., communication device 200 of FIG. 2). If the server 300 is communicating indirectly with the external communication device, then the server 300 is sending and receiving communications through a common network.

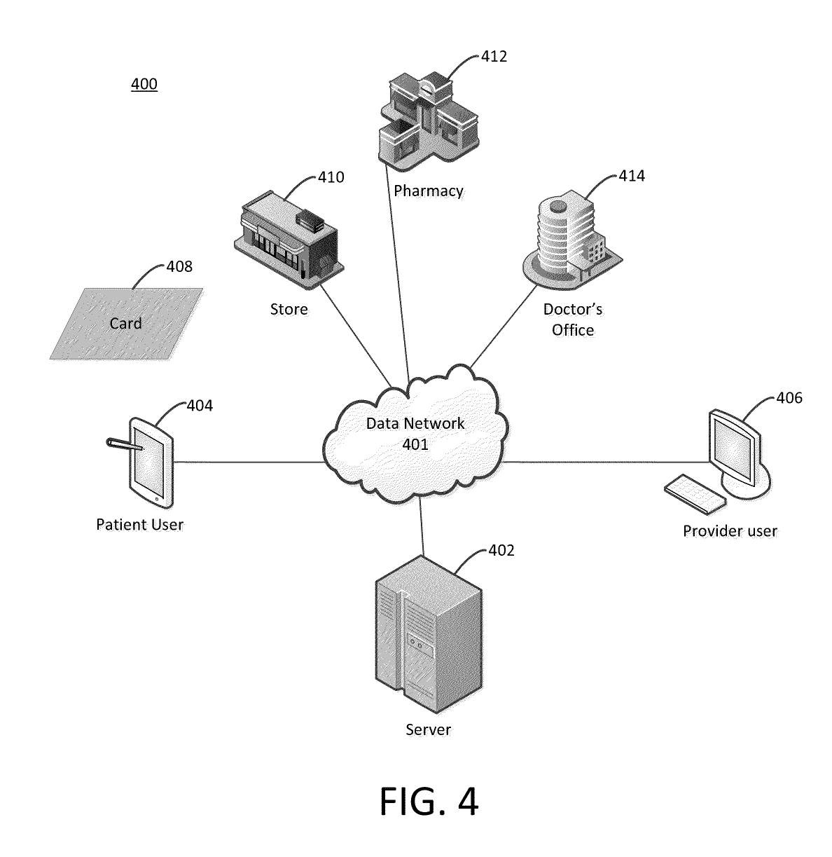

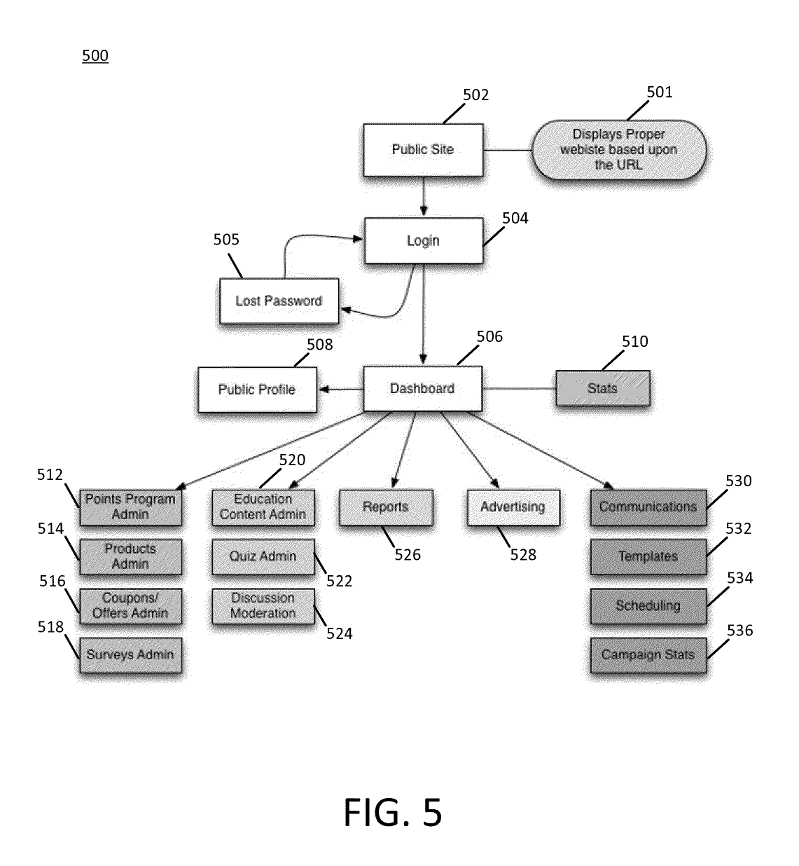

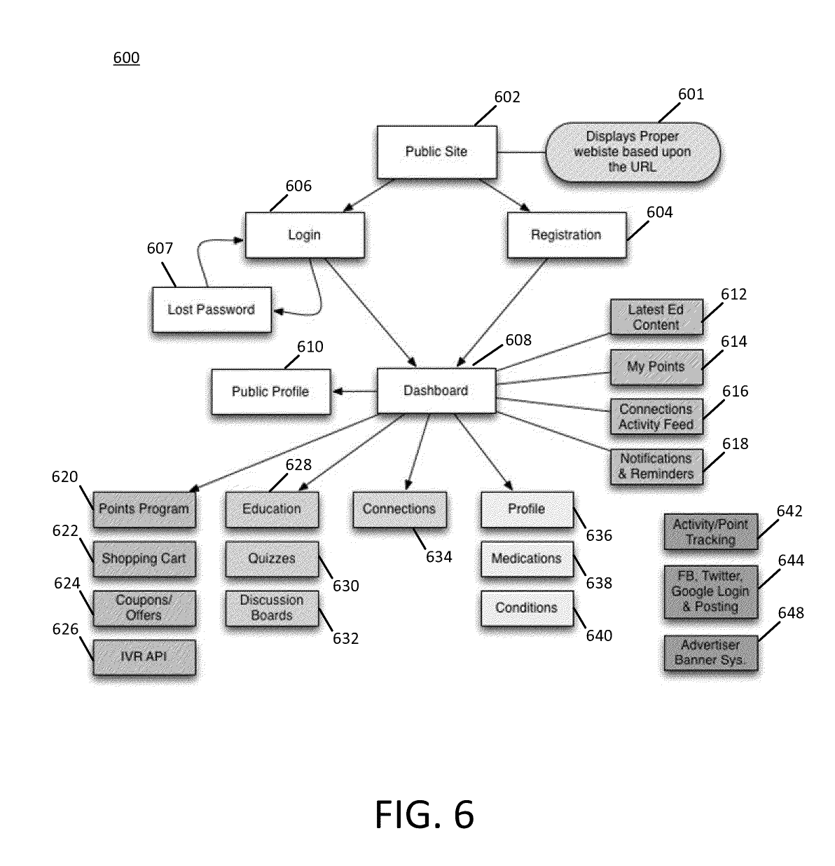

Referring now to FIG. 4, a system diagram is shown illustrating exemplary components of a system 400 according to various scenarios. FIG. 4 shows a server 402 connected to computing devices 404, 406 through data network 401. Data network 401 can be any data network including a local area network, wide area network, virtual private network, Internet, or other public or private network capable of transferring data from one connected device to another. Either or both of computing devices 404, 406 may be similar to computing device 200 described above with reference to FIG. 2. Server 402 may be similar to server 300 described above with reference to FIG. 3. In the scenario shown in FIG. 1, computing device 404 is a patient user device that allows a patient to interact with the system. Computing device 406, in contrast, is a provider user device that allows a provider to interact with the system. The ways in which patients and providers interact with the system are different and are described in further detail below in reference to FIGS. 5 and 6.

System 400 also includes a card 408 that is usable at a number of point-of-service locations, such as store 410, pharmacy 412, and/or doctor's office/hospital 414. As used herein, the term “point-of-service” broadly refers to any location where the patient would purchase a good or service related to healthcare. Each point-of-service may be connected to server 402 through data network 401. In some scenarios, the card 408 may include encoded data which is read at a point-of-service. The card 408 may be a credit/debit card or customer loyalty card, for example. When a patient uses the card 408 at one of the points of purchase, a transaction processing company processes the transaction. In a scenario, the transaction processing company may capture data from the transaction that indicates that the patient engaged in an activity that is within a patient care plan. For example, if the patent was discharged from a hospital, readmission to the hospital is significantly reduced if the patient visits a doctor within 15 days from discharge. When the patient goes to the doctor's office and uses card 408, the transaction processing company can identify that activity, capture data relating to the patient's visit and provide that information to server 402. Similarly, if the patient goes to pharmacy 412 and uses card 408 to fill a necessary prescription, the transaction processing company can capture data relating to the prescription and provide that data to server 402. Data can also be captured from the patient's purchases at store 410 (e.g. a grocery store) to capture data on healthy purchases.

In some scenarios, the card 408 can serve as a dual purpose device: 1) it may provide a means for payment for the service or good that is purchased by the patient (e.g., through a credit card payment processor and/or through direct insurance company billing); and 2) it may provide a mechanism for capturing and transmitting data concerning the activities of the patient to the patient tracking and monitoring platform.

As described above, the platform on the server 402 can use the patient's transaction data to determine whether the patient is engaging in healthy behavior. In an example implementation the patient enrolls in the system and receives a card 408. The patient may activate the card by phone, web or other technology and/or opt in to the platform services. A set of patient data is provided to the platform that initiates a series of interventions, communications, and services.

For example, the platform will initiate a series of communications and services that will drive patient adherence with medication. In addition to points, the program will provide links to outside providers such as retail pharmacies 412 for the purposes of advertising and providing additional incentives to drive patient behaviors.

In another embodiment, the platform will initiate a series of communications and services that will drive patient education. In this embodiment, the end users will receive points for actively participating in education and validating comprehension via a passing score on a test. Tests can be administered by technology such as e-mail, IVR phone call, live customer service call, and by completing written tests. The software controlling these services may be resident on server 402.

In another embodiment, the platform will initiate a series of communications and services that will drive patient healthy purchasing behaviors. In addition to points, the program will provide links to outside providers such as food manufacturers and retailers, sporting good manufacturers and retailers, and other interested parties 410 for the purposes of advertising and providing additional incentives to drive patient behaviors.

For successfully participating in the system, patients will be rewarded with points which quantify their success and can be used to access additional rewards and discounts. Points will be tracked using a points tracking software.

In a hospital scenario, the platform operates as follows. On or before the day of patient discharge, a card 408 can be provided to the patient. Patients can activate their card to be enrolled in the program. Activation information is sent in real time, and patient receives an instant SMS text message or other confirmation with welcome note and initial discounts/offers. The patient is now enrolled in communication program.

In yet another embodiment, the platform can track patient fulfillment of discharge medications. Patient may receive IVR reminders if prescriptions are not filled within a predetermined timeframe. Upon filling of prescriptions at retail pharmacy, National Counsel for Prescription Drug Programs (NCPDP) information will be captured in real time, and patient will receive a message (IVR and/or instant SMS text message) with health information and/or discounts/offers. Patient receives points for filling their prescription on time.

Similarly, the platform can track patient health care activity. Patient will receive IVR reminders if predetermined healthcare activities are not performed within a predetermined timeframe. Upon visiting their physician, or other designated healthcare provider 414, patient swipes the card 408 in the available credit card reader, information is sent in real time, and patient receives a message (an IVR call or instant SMS text message) with health information and/or discount/offer. Patient receives points for healthy behavior.

Patient receives prompts (IVR and/or SMS text message) with offers to participate in patient education activities. Patient visits TPS website and performs activities (eg. Takes education program) and receives points

The platform will provide a series of post-discharge IVR calls with questions designed to assess patient status with “warm transfer” of the call or e-mail notification to the patient's primary care provider or other appropriate healthcare provider, for “red flag” responses. A Pre-visit Education and Resource Program (PREP) will provide a series of e-mails within the time period prior to the patient's first post-discharge primary care provider/cardiologist visit to help the patient prepare for the office visit. Patient outcomes will be tracked for up to one year after hospitalization Data points will be obtained including medication abandonment and compliance, follow-up visits, education participation and testing scores, and hospital readmissions.

Referring now to FIG. 5, a flow chart is provided showing an example structure for a provider user role 500. The provider user role 500 is one that, for example, allows a provider to administer content and control patient user interaction on a web portal or website. A provider may be a healthcare provider, hospital administration, insurance company, or other stakeholder that wishes to influence patient behavior using the platform described in this document.

The web portal is accessed by entering the proper uniform resource locator (URL) 501 into a web browser (not shown). The URL 501 directs the browser to a public site 502 which requests that the provider user log in to the platform via login 504. The login 504 also includes functionality that allows for recovery and/or replacement of lost passwords 505.

After the provider user logs in to the platform through login 504, the provider user is directed to the dashboard 506. The dashboard 506 is a home screen of the web portal that provides navigation paths to all other areas and functionality of the platform. A public profile 508 allows the provider user to enter information that will be viewed publically, for example, by patient users of the platform. A statistical profile 510 allows the provider user to see analytics and other statistical information concerning patient user performance and status.

Dashboard 506 also has numerous navigation links to administrative functions that allow the provider user to define and control patient user interactions with the web portal and the platform generally. In a first group of administrative functions, the provider user is given administrative control over the points program though a points program administration function 512. The points program administration function allows the provider user to control how points are earned and redeemed by the patient users on the platform. A provider user may assign point values to individual activities. For example, if the provider user wishes to incentivize education over discussion participation, the provider user may assign a high point value to education activities and a lower point value to the discussion activities on the website. Conversely, if the provider user wishes to incentivize discussion group participation over education, the provider may assign a higher point value to discussion participation than to education.

Likewise, the provider user may also assign point values for rewards designed to incentivize the patient to participate in the activities within the platform. For example, the provider may establish participation levels with defined goals the patient users must accomplish to reach each level. Additionally, a reward catalog or other listing of potential rewards may be established that allow the patient users to “spend” their points to get cash rewards, discounts, goods, and the like.

In at least one aspect of the invention, a products administration function 514 is also included. This function allows the provider user to administer all aspects of the various products available on the platform. These products include banner advertising, point levels, rewards systems, education content, patient participation requirements, communication programming, alerts and notifications device input, and any other activities associated with patient participation, and user customization.

In another embodiment, a coupons/offers administration function 516 is also included. This function allows the provider user to administer coupons and discount offers including the visibility of coupons and discounts to specific users and user groups, eligibility requirements for access to coupons and discounts, connection to coupons and offers that reside at other locations such as websites, inclusion of discounts and offers on a card such as a debit or credit card, and redemption of coupons and discount offers. This differs from the points program as the points program allows for the accumulation and redemption of points in exchange for access to these discounts and coupons.

In another embodiment, a surveys administration function 518 is also included. This function allows the provider user to design and implement surveys which gauge patient user status and information related to the patient user's healthcare behavior. These surveys can be implemented through IVR phone calls and/or as separate website interactions. For example, after a hospital discharge, a provider may wish to ask a series of questions to determine whether the patient is complying with a patient care plan established by the provider.

Another group of administrative modules provides the provider with extensive control over the educational content on the platform. Education content administration function 520 allows the provider user to select and assign individual educational modules to the patient user. For example, if the patient user is a newly diagnosed type 1 diabetic, the provider may wish the patient to view educational videos on how to properly inject insulin. In another example, if the patient was recently discharged after heart surgery, the provider may wish to patient to view educational videos on the importance of taking certain medications in the period immediately following discharge. One skilled in the art will recognize that the style and content of these educational modules are not limited.

A quiz administration function 522 is also included in the platform. This function allows the provider to develop and generate quizzes designed to determine whether the patient has effectively participated in the assigned education content. By requiring the patient to complete a quiz for each educational module, the provider will be able to monitor the actual effectiveness of the education content without relying on the word of the patient. If the provider wishes to assign points to for completion of the educational modules, the points may be awarded based on the patient user's performance on the quizzes. For example, if a patient user views an educational video, then is administered a quiz on the content in that video, the platform may award points when the patient user “passes” the quiz.

A discussion moderation function 524 is also included. This function allows the provider to moderate discussion forums and other social networking functions of the platform. Additionally, this function may also allow the provider to assign point values for interactions with the platforms. For example, if a patient user “likes” a discussion post, they may receive points. Additionally, posting discussion topics and replying to topics already posted may also earn points. The point values may be scaled to incentivize patient participation.

A reporting function 526 is also included. This function allows the provider to run analytic reports on patient interactions and status. Example reports could include levels of user participation in specific activities, website analytics such as time spent on the site by individual users or user groups, individual and aggregated performance and testing results for education, participation rates and results of IVR phone surveys, user demographic reports, individual and aggregate data and rating reports on levels of healthy behavior achieved, reports on user health outcomes which include user healthcare data, such as from an electronic medical record, and data from user participation in the platform.

An advertising function 528 is also included. This function allows the provider to control the advertising on the platform.

Another group of functions include communications 530, templates 532, scheduling 534, and campaign statistics 536. Administrators of the site can schedule communications for users including IVR calls, text messages, e-mails, faxes, and “live” phone calls from call center representatives. Communications can be scheduled, manually or automatically through the software, in any combination and frequency, individually for a distinct user or in the form of predetermined templates, based on the user data entered into the platform or imported from a database such as an electronic medical record. Statistics on patient participation in the communication program is captured and stored in the database for purposes of awarding points, accessing rewards, and reporting.

Referring now to FIG. 6, a flow chart is provided showing an example structure for a patient user role 600. The patient user role 600, for example, allows a patient to view content and participate in interactive portions of the web portal or website.

The web portal is accessed by entering the proper uniform resource locator (URL) 601 into a web browser (not shown). The URL 601 directs the browser to a public site 602 which allows a patient user to register via registration 604 or log in to the platform via login 606. The login 606 also includes functionality that allows for recovery and/or replacement of lost passwords 607.

After the patient user logs in to the platform through login 606, the patient user is directed to the dashboard 608. The dashboard 608 is a home screen of the web portal that provides navigation paths to all other areas and functionality of the platform. A public profile 610 allows the patient user to enter information that will be viewed publically, for example, by patient users of the platform. Other dashboard functions include latest educational content 612, my points 614, connections activity feed 616, and notifications and reminders 618. These functions allow the patient user to quickly access the latest content and up-to-date access to account details and social networking feeds.

Dashboard 608 provides a number of navigation links to various functions of the platform. In one group of functions, the patient user may access patient points function 620 to access the patient points program. This function allows the patient user to view their earned points as well as information describing the points program and how to earn additional points. Also available is a catalog of available rewards that patient users can purchase by “spending” their points. The rewards may be purchased through shopping card 622. Further, coupons and offers 624 may be provided by the platform. These coupons and offers may be given as rewards for interacting with the website.

IVR application programming interface (API) 626 includes functionality that can place an automated phone call to the patient. The IVR phone calls are used to survey the patient to get information concerning their health status and compliance with the patient care plan. IVR phone calls can also provide reminders to perform certain activities, such as filling a critical medication or attending to a doctor's office visit. The API 626 also allows the provider user to pull data concerning the results of the IVR calls including which patients were called, the answers to the survey questions provided by the patients, and other information related to the disposition of the phone call. The information pulled from the IVR phone calls can also be used to red flag patient behaviors that are not in compliance with critical portions of the patient care plan.

Dashboard 608 also provides access to the educational modules of the platform. The education function 628 allows the patient to search, browse, and view the educational content available on the system. For example, the educational modules that have been assigned to the patient user may appear, allowing the patient to view them. Other educational modules may also be available for viewing.

A quiz function 630 may also be available to ensure that patients actually view and comprehend the educational content. The quizzes may be automatically provided to the patient after viewing a particular educational module or may be selected by the patient after viewing the module. As noted above, any points the provider may wish to award to the patient for viewing the education content may be awarded based on the patient's performance on these quizzes.

A discussion board function 632 is also included. The discussion board function 632 allows the patient to interact with other patients and healthcare providers and experts directly. Patients may have the ability to post new topics, reply to previously posted topics, “like” topics and/or replies, and engage in any number of other interactions common among social networking websites. Also included is a connections function 634 which allows the patient to find and explore social networking connections using the platform. Through connections function 634, the patient can connect to other patients, care givers, doctors, and other providers. The platform also enables all the parties that have made connections to see the activity of each other on the website.

A profile function 636 is also included. The profile function allows the patient to enter their profile information to identify themselves publically through the social network functionality of the platform, i.e. public profile 610. The profile may also include non-public information designed enhance the ability of the platform to track patient behavior and to incentivize healthier behavioral choices. For example, a medications function 638 allows the patient to enter their medications. This information can be used by the platform to establish schedules that remind and incentivize the patient to take and refill their medications as recommended. Additionally, a conditions function 640 is also included that allows the patient to enter their health conditions, such as diseases and other infirmities, from which the platform may also establish schedules and patterns of care. Collectively these schedules are referred to as a patient care plan.

In an example, a patient is discharged from the hospital after heart surgery and is prescribed an anti-coagulant. The patient (or agent of the provider, e.g. the discharging nurse) registers on the platform and enters a heart condition and the medication they have been prescribed. The platform automatically generates a patient care plan that includes a time window for the patient to fill their medication prescription and for a follow up doctor's visit. The patient care plan may include reminders informing the patient of where they can fill the prescription, when to fill the prescription, any information needed in preparation for the follow up doctor's visit, and the like. The patient care plan may also include educational modules assigned by the physician or other healthcare provider, e.g., an educational video or reading selection describing the importance of taking an anti-coagulant after heart surgery. The patient care plan may also include a list of activities for which the provider will award points. These activities will ideally be activities designed to incentivize good healthcare behavior.

Functions may also be included that allow for activity/point tracking 642, social networking connectivity 644, and advertising systems 648. These functions are not directly controlled by the patient user, but are functions that impact patient user experience on the platform. For example, the activity/point tracking function 642 allows a provider user to review and monitor the patient's interactions with the patient points function 620. The social networking connectivity function 644 allows the patients to post items from the platform directly to social networking platforms such as Facebook and Twitter. Other users on those platforms are, then, able to view and share in the patient's activity on the platform. The advertising systems function 648 provides advertising functionality, controlled by the provider or site owner to enable a revenue stream to cover any costs of maintaining the platform.

Exemplary Methods

Exemplary methods of using the disclosed platform are illustrated through a series of flow charts in FIGS. 7-10. The methods disclosed are merely examples to provide detail on how the disclosed platform assists patients and their healthcare providers to track and influence patient behavior to produce better healthcare outcomes and to reduce hospital admissions and/or readmissions.

Referring now to FIG. 7, a flow chart is provided of an scenario for a method 700 of the disclosed platform. The platform receives patient identifying data 702. Patient identifying data may include any information usable to identify the patient. In a simple example, patient identifying data may only include a first and last name and an email address, which would typically be sufficient individually, identify a particular patient. Additional detailed information, such as that relevant to the patient's medical status, may also be included without limitation. From the patient identifying information, the platform generates a patient profile 704.

The patient profile may include both public and non-public (i.e. private) components. The public patient profile includes profile information which is visible to any user registered on the platform or any user accessing the public website. The site owner may decide to restrict access to public profile information to only registered users or may allow public information to be freely accessible without registration.

The private profile may include more sensitive information including the patient's medical history and the like. The private profile may only be accessible by the patient and other privileged users which obtain the patients permission in exchange for access to the private profile data. For example, a patient may wish to allow his/her primary care physician to have access to the private profile data.

The platform also receives patient care indicators 706. Patient care indicators are indicators that identify particular conditions and/or medications associated with the patient. For example, the patient may have type I diabetes and have a prescription for insulin. Both “type I diabetes” and “insulin” are each patient care indicators. Each may be represented by a code or other indicator which the platform can use to identify the particular medical condition and/or medication.

Using the profile data and patient care indicators, the platform generates a customized patient care plan that includes one or more patient care modules 708. Various combinations of patient profile data and patient care indicators may suggest particular patient care modules to be included in the patient care plan. For example, if a patient is discharged from a hospital following heart surgery and has been prescribed a particular medication which must be taken to reduce the chances of hospital readmission, the platform may generate a patient care plan with a schedule which defines a set time for the medication to be filled and refilled and when the patient should be taking the medication. This medication schedule may be one patient care module for the patient to comply with. Further, the patient care plan may include an follow up office visit within a set amount of time. The office visits schedule may represent another patient care module for the patient to comply with. Educational modules designed to inform the patient on the importance of taking the prescribed medication may also be included. Other examples of patient care modules include a suggested dietary regimen, a suggested fitness regimen, and/or any other activity or course of action which is recommended and/or assigned to the patient by a healthcare provider.

The platform receives one or more compliance indicators 710. A compliance indicator is data that indicates whether the patient has complied with a particular patient care module. For example, if the patient is supposed to fill their prescription within a week of discharge, data may be received with indicates whether the patient has or has not filled the prescription. The indicator may also be an absence of data, e.g. that no data has been received indicating the prescription has been filled. In either case, the platform receives an indication that at least some portion of the module has not been complied with.

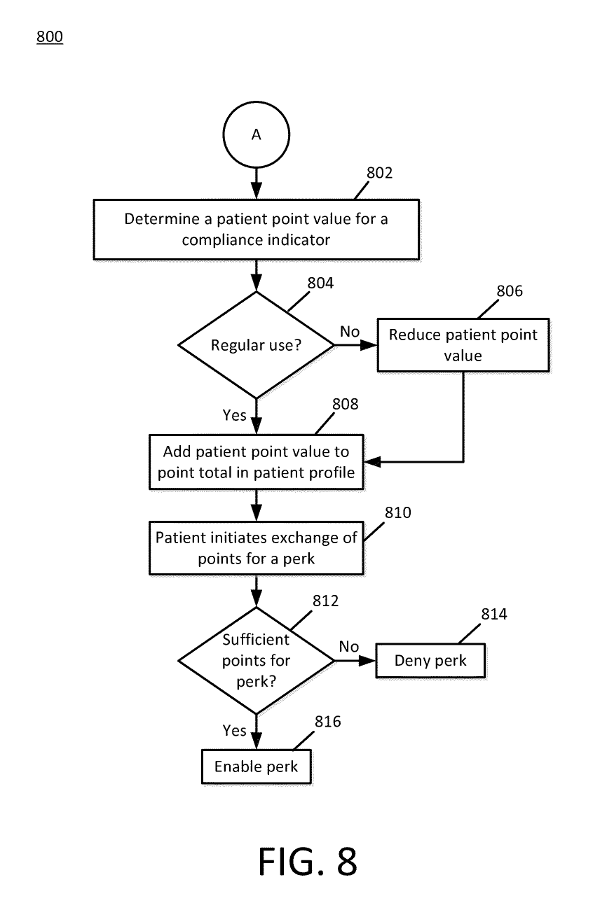

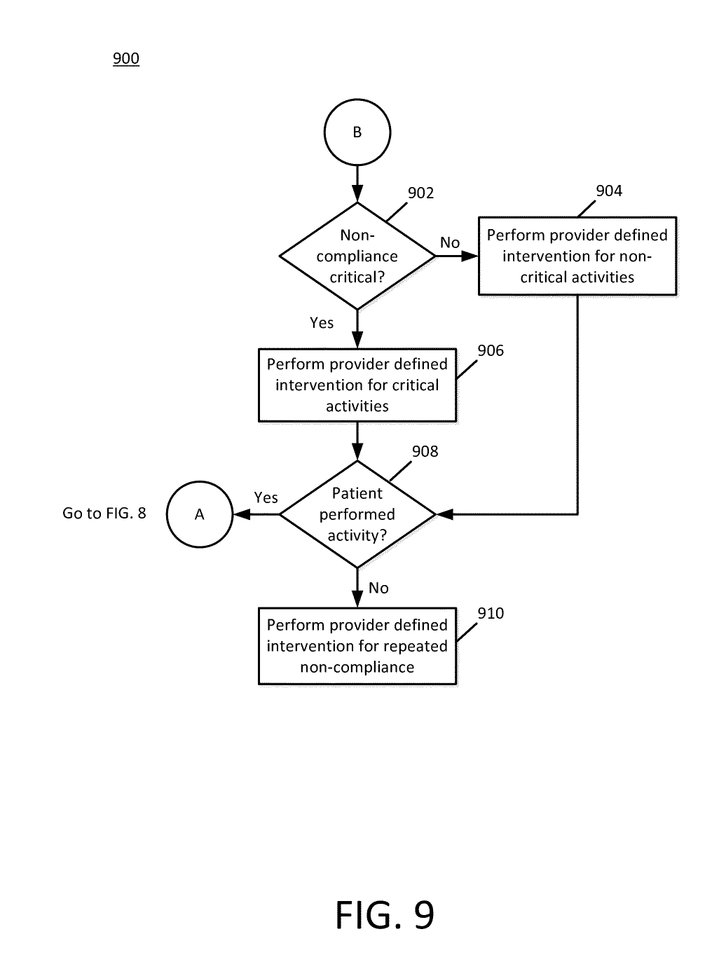

Using the compliance indicators, the patient's compliance with a patient care module and/or a patient care plan is assessed 712. As used in this document, compliance means that the patient has engaged in an assigned activity. For example, if the patient is supposed to fill a prescription within a set amount of time, the patient is compliant if the prescription is filled within the amount of time given. The patient is not compliant (i.e., non-compliant) if the prescription has not been filled within the amount of time given. Alternatively, a patient is compliant if they have successfully completed an educational module and/or passed a quiz on the educational content. If the patient is compliant (714: Yes), the platform may determine a point value, if any, to award the patient for their compliance with the patient care module and/or plan. The point award is described in more detail below in reference to FIG. 8. If, however, the patient is not compliant (714: No), an appropriate intervention is determined, as described in more detail in reference to FIG. 9.

The platform rewards a compliant patient as one method of incentivizing a patient to engage in healthy behavior. Referring now to FIG. 8,. flow chart is provided that shows an example method 800 of awarding points to a compliant patient. After a patient is determined to be compliant (714: Yes of FIG. 7), the platform determines a point value to assign to the compliance indicator 802. The point value may be determined by referring to a table of point values associated with all possible compliance indicators. For example, after a patient views an educational module and passes a quiz covering the content of that educational module, the platform consults a table which includes an amount of points that are associated with completing one educational module. In this example, the number of points associated with the educational module may be 10 points. Therefore, after completing the educational module and passing the quiz, the platform determines that the educational module has a value of 10 points. The amount of points given for a particular compliance indicator is entirely arbitrary and can be set in advance by a provider or other site owner. For example, the provider may wish that the educational module have 100 points, rather than 10, to increase the incentive for the patient user. Alternatively, if the provider wishes to not incentivize educational modules, the point value can be set to zero. The platform allows the provider to design the points system that is best suited for accomplishing the provider's goals of reducing patient readmission and improving patient outcomes.

In most cases, the point value determined above, will be added to the patients total point value. However, other factors may affect how many points get added to the patient's total. In the example provided in FIG. 8, the platform checks to determine how regularly the patient has used the platform 804. If the patient has used the platform within a reasonable period of time (804: Yes) the point value is added to the patients point total in the patient profile 808. However, if the patient has not used the platform in a reasonable amount of time, the patient point value is reduced by some amount 806. This feature allows for the provider to reward the patient based on consistent use. For example, the provider may set the reasonable amount of time to be one week. If the patient earns points, but has not logged on in more one week, the point value that is actually applied to the patient's profile is reduced. In one scenario, a percentage of the point value may subtracted for each week the patient does not log in to the platform. In an alternative scenario, a set amount (e.g. half) of the point value may be subtracted. Any method of reducing the point value may be used without limitation. After the point value has been reduced, it is added to the patient point total in the patient's profile 808.

After the patient as accrued a sufficient amount of points, they may elect to exchange some portion of the points for a perk 810. After the patient initiates the point exchange, the platform checks to make sure the patient has enough points to receive the perk 812. If the patient does have sufficient points for the perk (812: Yes) the perk is enabled or awarded to the patient 816. In one scenario, the perk may be a percentage discount on prescription medications or a discount generally at a pharmacy. Alternatively, the perk may be a cash award deposited into the patient's bank account or automatically credited to their next prescription refill. Perks that may be available for exchange by patients are not limited. If the patient does not have enough points (812: No), the platform denies the perk 814.

Referring now to FIG. 9, a scenario for performing an intervention is shown. The platform determines whether the non-compliance was “critical” 902. As used in this document a “critical” non-compliance may refer to a failure of a patient to fill a prescription of a necessary medication or a failure to attend to a necessary office visit. Any activity that a provider deems to be necessary for improving the patient's healthcare outcome can be designated as critical. Such designations may be specified in the patient care plan. Non-compliance that is not critical is a failure of a patient to comply with any other assigned module in the patient care plan. For example, an educational module may not be designed as critical. Therefore, failure of the patient to view the educational content would not be considered a critical non-compliance.

If the non-compliance is not critical (902: No), the platform performs a provider defined intervention for non-critical activities 904. Such interventions may include, placing notifications on the platform website, sending an SMS message, sending an email, placing an IVR phone call, sending a fax, and the like. If the non-compliance is determined to be critical (902: Yes) the platform performs an provider defined intervention for critical activities 906. Critical non-compliance may trigger similar actions, but may trigger more of them. For example, an email, SMS message, and an IVR phone call may be send at the same time. Additionally, the message or phone call may be sent to a third party, such as a child caregiver or a doctor's office. The provider is able to define the intervention which works best for the patient population they are responsible for. Additionally, the interventions may be fine-tuned in coordination with the third party. In one scenario, a doctor's office may request that critical interventions be sent via fax only. Alternatively, they may request that the critical interventions be sent via a phone call only. The provider's ability to configure the interventions is not limited in any way.

The platform determines if the intervention has succeeded in incentivizing the patient to perform the activity to be compliant 908. This determination is made in a similar fashion to the determination of whether the patient was compliant in the first instance (714 of FIG. 7). If the patient is compliant (908: Yes), the patient is rewarded for their compliance as described above in reference to FIG. 8. If the patient is found to still be non-compliant (908: No) the platform performs a provider defined intervention for repeated non-compliance 910. Repeated non-compliance identifies a pattern of non-compliance. In a scenario, repeated non-compliance may be found when an intervention fails to incentivize the patient that has already exhibited non-compliance one activity. Alternatively, repeated non-compliance may only be found when a critical non-compliance is not corrected through an intervention. The scenarios are not limited in this regard.

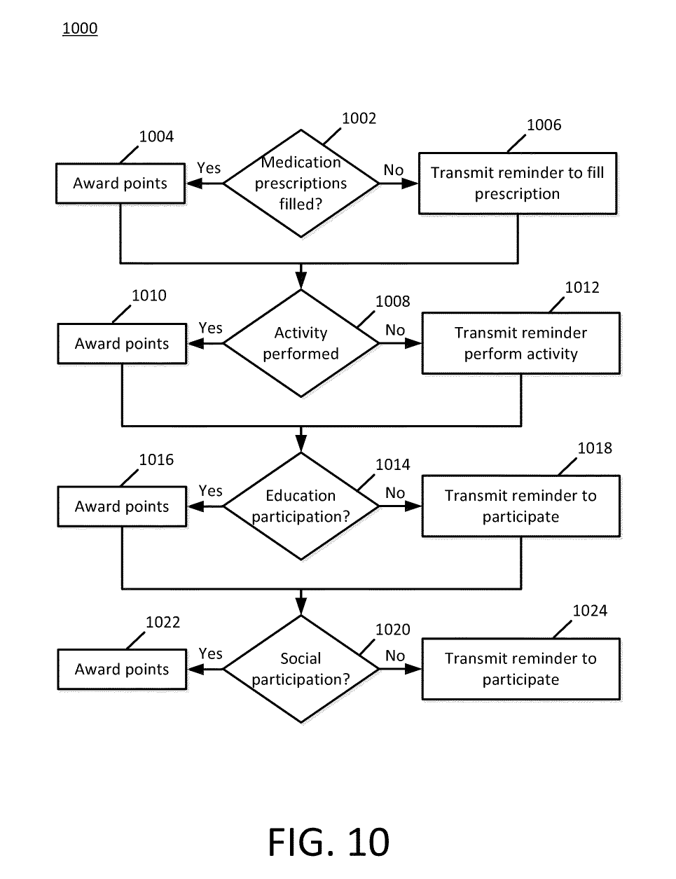

Referring now to FIG. 10, a scenario is shown for an example reminder system that may be included into the compliance determination. A provider may wish to implement any or all of these reminders. At defined times or in regular intervals, the system may determine whether a patient's medication prescription has been filled 1002. If it has (1002: Yes), then the platform awards points to the patient through the points program of the platform 1004. If the prescription has not been filled (1002: No), a reminder is sent to the patient to fill the prescription 1006. The reminder may be in the form of a notification on the platform website, an SMS message, an email, an IVR phone call, a fax, and the like.

The system may also determine whether an activity has been performed 1008. An activity may be any activity which the provider recommends the patient perform. Examples include, making an office visit, buying healthy food options, exercising at a gym, and the like. If the activity has been performed (1008: Yes), then the platform awards points to the patient through the points program of the platform 1010. If the activity has not been performed (1008: No), a reminder is sent to the patient to perform the activity 1012. The reminder may be in the form of a notification on the platform website, an SMS message, an email, an IVR phone call, a fax, and the like.

The system may also determine whether the patient has participated in an education module 1014. If the patient has participated in the education module (1014: Yes), then the platform awards points to the patient through the points program of the platform 1016. If the patient has not participated in the education module (1008: No), a reminder is sent to the patient to participate 1018. The reminder may be in the form of a notification on the platform website, an SMS message, an email, an IVR phone call, a fax, and the like.

The system may also determine whether the patient has participated in a social networking function 1020. If the patient has participated in the social networking function (1020: Yes), then the platform awards points to the patient through the points program of the platform 1022. If the patient has not participated in the social networking function (1020: No), a reminder is sent to the patient to participate 1024. The reminder may be in the form of a notification on the platform website, an SMS message, an email, an IVR phone call, a fax, and the like.

In order to optimize and improve patient care, a pilot study for a care transition program was implemented at a community based hospital, which included IVR phone calls with triage to a care navigator. The program was designed to serve patients 65 and older suffering from multiple chronic conditions and social vulnerability who are high utilizers of health resources with intent to improve care plan coordination and patient education from a trigger point at patient enrollment through 30 days after patient is discharged from the hospital

In this program, patients who admitted six times or more in the year; or readmitted within 30 days; or identified “at risk” on admission screen were identified for enrollment into the program. Such patient population tends to be readmitted to the hospital within 30 days after they are discharged from a hospital or a care facility. The goal of the study program was to address gaps in care among the enrolled patient population who are at most risk to exhaust health resources. Other goals included (1) integrating technology to improve information flow and provide scalability; (2) formalizing relationships with partners to optimize transitions from emergency room or inpatient units to diverse community settings; (3) promoting patient self management and (4) augmenting the discharge processes from the participating healthcare facility.

For hospital admitted patients, an evidence based screening tool was employed to capture social and health information for potential patient candidates. This tool was used to identify risk stratify patients to advance coordination of care and education. Subsequently a transition coach was assigned to (1) facilitate goal setting, by educating patients and families on self-management, in collaboration with participating hospital staff, (2) trigger a referral to care transition program to engage with a case manager for transitional care planning, and (3) become available to direct and/or address patient problems for at least 30 days post-discharge.

Prior to discharge to home, participating patients received an individualized discharge information kit and provided specific teaching modules prior to discharge. Since access to medications is a critical factor for patient outcomes, a local pharmacy deliver a 30 day supply of medications on the day of discharge. In at least one alternative scenario, medication assistance options were explored for patients without medication coverage. Prior to discharge, patients were encouraged to accept homecare services when appropriate, and a follow up plan was instituted. If homecare is accepted, the follow up communication and services was performed through a participating contracted agency, with a link to the assigned coach. However, if a participating patient does not accept homecare services, telemedicine follow up would be instituted, along with a potential access to a secondary healthcare facility. In an alternative approach, a link back to the a personalized coach, and other care providers as needed, would be offered, if a red flag is identified

At the global level, the program integrated via the presently disclosed web-based technologies such healthcare services as at least a retail pharmacy and transition services, the participating hospital pharmacy, patient's insurance groups, at least one health care facility such as a hospital or a hospice and a homecare provider. Under this program the integrated services address medication access and adherence, streamline prescription assistance program access, enhance patient education, track high-risk patients and behaviors, facilitate information transfer of core data elements among participating facilities and improve electronic health records access to healthcare providers.

By the completion of the study period, the inventors observed that the 30-day all-cause re-hospitalization rates among patients enrolled in the program was reduced from 57.1% to 30%. The program also significantly improved patient HCACPS scores by reducing readmissions for high-risk Medicare patients, irrespective of diagnosis. The obtained data provides that adherence to presently described customized patient care plan reduces the patient's likelihood of hospital admission or readmission thereby advancing patient behavior and improving patient care outcomes.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method performed by an electronic circuit for tracking and modifying a patient's behavior, the method comprising:
receiving a first set of patient specific data comprising information that identifies a patient;
receiving a second set of patient specific data comprising one or more patient care indicators associated with the patient;
comparing the second set of patient specific data against a database that relates each patient care indicator with at least one patient care module;
generating a customized patient care plan comprising one or more patient care module(s) wherein each module includes one or more activity(ies) assigned to the patient;
receiving a third set of patient specific data comprising one or more compliance indicators, wherein the one or more compliance indicators indicate the patient's interactions with the one or more of patient care module(s);
assessing patient behavior based on the third set of patient specific data, wherein the one or more compliance indicators indicate whether the patient completed the activity(ies) assigned to the patient; and
issuing a reward to a patient on a condition that the patient adheres to the customized patient care plan, enabling the patient to utilize the reward.

2. The method according to claim 1, further comprising:
generating a patient profile based on the first set of patient specific data; and
associating the patient care plan and the patient profile.

3. The method according to claim 2, further comprising:
determining a patient point value for each compliance indicator that indicates that the patient completed an assigned activity within the customized patient care plan; and
adding each patient point value that is determined to a point total associated with the patient profile.

4. The method according to claim 3, wherein enabling the patient to receive the reward comprises displaying a list of a plurality rewards that are redeemable by exchanging at least a portion of the point total for each of the rewards.

5. The method according to claim 1, wherein one of the patient care modules comprises a medication adherence plan that comprises:
an indication of one or more medications prescribed to the patient;
a dosage level for each medication;
a dosage frequency for each medication; and
a refill time window representing a period of time during which the patient should refill the medication.

6. The method according to claim 5, wherein the third set of data comprises:
an indication of the frequency at which the user takes the medication;
an indication of whether the user has refilled the medication; and
an indication of whether the user has participated in the at least one patient education program.

7. The method according to claim 1, further comprising aggregating the patient's interaction with said activity(ies) to create a compliance profile for the patient.

8. The method according to claim 1, wherein the adherence to the patient care plan reduces the patient's likelihood of hospital admission or readmission with the patient care plan.

9. The method according to claim 1, further comprising performing a medical intervention on a condition that the patient's behavior indicates non-compliance with the customized patient care plan.

10. The method according to claim 1, wherein the reward is issued through one of a pre-paid debit card, a coupon, a discount, and a cash payment.

11. A system for tracking and modifying a patient's behavior, the system comprising:
a terminal configured to capture a first set of patient specific data comprising information that identifies a patient and a second set of patient specific data comprising one or more patient care indicators associated with the patient;
a device configured to capture a third set of patient specific data comprising one or more compliance indicators; and
a server comprising
a processor; and
a computer readable medium configured to store program instructions which, when executed, cause the processor to:
generate a patient profile based on the first set of patient specific information;
generate a customized patient care plan comprising one or more patient care module(s) wherein each module includes one or more activity(ies) assigned to the patient by comparing a second set of patient specific data comprising one or more patient care indicators associated with the patient against a database that relates each patient care indicator with at least one patient care module;
assess patient behavior based on the third set of patient specific data, wherein the one or more compliance indicators indicate the patient's interactions with the one or more of patient care module(s), wherein the one or more compliance indicators indicate whether the patient completed the activity(ies) assigned to the patient; and
issue a reward to a patient on a condition that the patient adheres to the customized patient care plan, enabling the patient to utilize the reward.

12. The system according to claim 11, wherein one of the patient care modules comprise a medication adherence plan that comprises:
an indication of one or more medications prescribed to the patient;
a dosage level for each medication;
a dosage frequency for each medication; and
a refill time window representing a period of time during which the patient should refill the medication.

13. The system according to claim 11, wherein the third set of data comprises:
an indication of the frequency at which the user takes the medication;
an indication of whether the user has refilled the medication; and
an indication of whether the user has participated in the at least one patient education program.

14. The system according to claim 11, further comprising aggregating the patient's interaction with said activity(ies) to create a compliance profile for the patient.

15. The system according to claim 11, wherein the adherence to the patient care plan reduces the patient's likelihood of hospital admission or readmission with the patient care plan.

16. The system according to claim 11, further comprising performing a medical intervention on a condition that the patient's behavior indicates non-compliance with the customized patient care plan.

17. The system according to claim 11, wherein the device is a swipable card comprising encoded data, the system further comprising:
a point-of-service device configured to retrieve the encoded data from the device when the device is swiped at the point-of-service device and configured to retrieve one or more compliance indicators based on the patient's activity at a point-of-service; and
a data network connecting the point-of-service device and the server, wherein the point of service device is further configured transmit the encoded data and the one or more compliance indicator(s) to the server.

18. The system according to claim 17, wherein the third set of patient specific data is generated based on the encoded data and the one or more compliance indicator(s).

19. A computing device for tracking and modifying a patient's behavior, the device comprising:
an interface configured to receive patient specific data;
a processor; and
a computer readable medium configured to store program instructions which, when executed, cause the processor to:
receive a first set of patient specific data comprising information that identifies a patient;
generate a patient profile based on the first set of patient specific data;
receive a second set of patient specific data comprising one or more patient care indicators associated with the patient;
compare the second set of patient specific data against a database that relates each patient care indicator with at least one patient care module;
generate a customized patient care plan comprising one or more patient care module(s) wherein each module includes one or more activity(ies) assigned to the patient and associate the patient care plan and the patient profile;
receive a third set of patient specific data comprising one or more compliance indicators, wherein the one or more compliance indicators indicate the patient's interactions with the one or more of patient care module(s);
assess patient behavior based on the third set of patient specific data, wherein the one or more compliance indicators indicate whether the patient completed the activity(ies) assigned to the patient; and
issue a reward to a patient on a condition that the patient adheres to the customized patient care plan, enabling the patient to utilize the reward.

20. The method according to claim 19, further comprising:
determining a patient point value for each compliance indicator that indicates that the patient completed an assigned activity within the customized patient care plan; and
adding each patient point value that is determined to a point total associated with the patient profile.
